(19) United States
(12) Patent Application Publication
(10) Pub. No.: US 2011/0129610 A1
(43) Pub. Date: Jun. 2, 2011

(54) METHOD FOR COATING A HARD SURFACE WITH AN ANTI-FILMING COMPOSITION

(76) Inventors: Patrick Fimin August Delplancke, Steenhuize-Wijnhuize (BE); Annick Julia Oscar Mertens, Bornem (BE); Xinbei Song, Cincinnati, OH (US)

(21) Appl. No.: 12/627,357

(22) Filed: Nov. 30, 2009

(51) Int. Cl. B05D 1/02

(52) U.S. Cl. 427/427.6

(57) ABSTRACT

The present invention generally relates to a method of coating a hard surface, particularly glass, with an anti-filming composition comprising the steps of contacting the hard surface with an effective amount of a composition comprising a water-soluble polymer, wherein the water-soluble polymer comprises an alkoxylated polyacrylic acid.

### FIELD OF THE INVENTION

The present invention relates to method for coating hard surfaces with an anti-filming agent comprising a water-soluble alkoxylated acrylic acid polymer.

### BACKGROUND OF THE INVENTION

It is understood that good hard surface cleaners, and particularly glass cleaners, provide various disparate characteristics. These characteristics optimally include good detergency, acceptable evaporability, streak-resistance and the like. In view of the often contradictory nature of these features, it has proven quite difficult to produce a glass cleaner which attains them all.

Conventional liquid hard surface cleaners use a water-based system with detergent and an organic solvent. For reasons of household safety and commercial acceptance, hard surface cleaners are nearly universally water based. However, water-soluble organic detergents generally exhibit poor detergency. While detergent builders increase detergency by sequestering polyvalent metal ions, inorganic builders are generally known to cause filming and streaking.

Generally, the hard surface cleaner is applied to a contaminated surface to loosen dirt while emulsifying oil and grease. The offending solubilized materials are thereafter wiped from the contaminated surface. If the oil and grease are not completely emulsified, or are not completely transferred to the wiping material, streaking and smearing occurs.

In the case of glass, other problems may arise when relatively cool non-porous surfaces are exposed to a warm moist atmosphere, since the cool surface will become fogged. In particular, glass fogging occurs by the condensation of steam or water vapor when the surface temperature of the non-porous surface is below the dewpoint. The opaque fog is therefore caused by the condensation of moisture droplets onto the non-porous surface. Naturally, this is undesirable for windows, mirrors, face masks, spectacles and the like. Additionally, in the case of hard water, calcium and metal deposits may form a film on glass surfaces over time.

Previous attempts to reduce or eliminate fogging include providing double-pane sheets to isolate the cooler glass pane from the warmer moist atmosphere. However, this is not practicable for many devices, such as minors. It is also possible to treat the surface to increase its porosity. However, increasing the porosity of surfaces obviously degrades the optical characteristics of minors, windows and the like. Other methods of avoiding fogging include treating the non-porous surface with hydrophilic chemicals that tend to decrease the incidence of droplet formation. In general, such surface active agents reduce the surface tension of the glass and encourage the individual water droplets to coalesce into a sheet. But these materials may also impart undesirable optical properties to the treated surface.

Therefore, there is a need for a hard surface cleansing composition which provides good detergency while preventing fogging, streaking, and/or deposition of precipitated metals.

### SUMMARY OF THE INVENTION

The present invention generally relates to a method of coating a hard surface, particularly glass, with an anti-filming composition comprising the steps of contacting the hard surface with an effective amount of a composition comprising a water-soluble alkoxylated acrylic acid.

### DETAILED DESCRIPTION OF THE INVENTION

While the specification concludes with claims that particularly point out and distinctly claim the invention, it is believed the present invention will be better understood from the following description.

All percentages, parts and ratios are based upon the total weight of the compositions, unless otherwise specified. All such weights as they pertain to listed ingredients are based on the active level, and therefore, do not include solvents or by-products that may be included in commercially available materials, unless otherwise specified. The term “weight percent” may be denoted as “wt %” herein.

All molecular weights as used herein are weight average molecular weights expressed as grams/mole, unless otherwise specified.

The present invention includes a method of coating a hard surface with an anti-filming composition comprising the steps of contacting the hard surface with an effective amount of a composition comprising a water-soluble alkoxylated acrylic acid. The compositions may also comprise other ingredients such as an aqueous and/or organic solvent, a coloring agent, and perfume. Other optional components may include, but are not limited to, ammonia, vinegar, chelating agents, pH modifiers, hydrotropes, antimicrobial compounds, and other conventional ingredients. These and other features of the invention will be discussed hereinafter.

### Hard Surfaces

There are generally seven basic types of hard surface plastics which include polyethylene terephthalate (PET), high density polyethylene (HDPE), polyvinyl chloride (PVC), low density polyethylene (LDPE), polypropylene (PP), polystyrene (PS), polymers and mixtures thereof. Manufacturers are unlimited in the number and types of articles that can be made from plastic. Carbon and graphite fibers are high-strength materials that are used as reinforcing agents in plastic composites. Examples of plastic articles include bottles, jars, jugs, bags, covers, pipes, furniture, containers, caps, cups, trays, aircraft fuselages and wings, spacecraft structures, and sports equipment.

Fiberglass surfaces comprise resins, polymers, reinforcing fabric and fibers. Hard surfaces made from fiberglass include but are not limited to bathtubs, boats, motorcycles, car bodies, canoes, airplanes, model aircraft, jet skis, sculptures, as well as traditional industrial molding and model-making articles.

Both ferrous and nonferrous metal surfaces are available for use with this invention. These include aluminum, brass, bronze, chrome, copper, tin, zinc, iron, stainless steel and steel. Examples of metal surfaces include (e.g. buildings, doors, window frames, automobiles, boats, structures, and many more too numerous to mention).

There are three basic types of glass-sheet, plate, and float. These basic glass types can be changed to meet modern requirements for comfort, security, safety, and architectural needs by adding chemicals or other ingredients during fabrication and processing.

There are a number of distinct dishware surface types available. Dishware can include glassware, ceramic ware, plastic ware, wood ware and metal ware. Examples of dishware include agateware, basalt, bisque, bone china, cauliflower ware, cream ware, delft, earthenware, flambe, hard paste porcelain, ironstone, jackfield, jasper, lusterware, majolica, marbled, parian, pate-sur-pate, pearl ware, porcelain, redware, salt glaze, slipware, snowman-porcelain, soft paste porcelain, spatter ware, staffordshire figures, stoneware, tortoiseshell, and transfer ware. Utensils can also be made from any of the above materials.

Ceramic surfaces include glazed tile, mosaic tile, and quarry tile. Applications of ceramic tiles include countertops, walls, floors, ceilings and appliances.

Other types of surfaces, such as sinks, bath tubs, and toilets may be made of porcelain, ceramic, or other materials.

There are many types of wood surfaces available. Examples of some types of wood include wood surface is selected from the group consisting of alder, ash, aspen, beech, birch, bocote, bubing a, butternut, cedar, cherry, cocobolo, canarywood, cypress, ebony, hickory, holly, kingwood, lacewood, locust, mahogany, maple, oak, osage, parawood, padauk, pecan, persimmon, poplar, purpleheart, redheart, rosewood, spanish cedar, sycamore, teak, tulipwood, walnut, wenge, zebrawood, ziricote. Articles made from wood can include furniture, baseball bats, chairs, stools, furniture, handles, motor-vehicle parts, barrels and crates, sporting and athletic goods, railroad ties, veneer, flooring, treated lumber, such as that used for decks, siding, crates, and interior finishing.

There are three basic types of stone surfaces available—igneous, metamorphic and sedimentary. Some of these surfaces include granite, marble, slate, sandstone, serpentinite, schistose gneiss, quartzite, sandstone, limestone and fieldstone. Stone is often used in construction of buildings, roads, walls, fireplaces and monuments. There are a number of types of concrete surfaces available as well. These surfaces include unreinforced concrete, reinforced concrete, cast-in-place concrete, precast concrete, post-tensioned concrete, and prestressed concrete. Examples of concrete surfaces include building components, bridge components, walls, streets, curbs and gutters. Asphalt comes in four types—hot-mix asphalt, cold-mix asphalt, glassphalt and rubberized asphalt. Asphalt is used on road surfaces, walls, roofing and sporting tracks. There are a multitude of mineral surfaces available. Minerals comprise ores of metal and other natural substances that can be mined. Examples of mineral surfaces may include jewelry, furniture, building components and many more. Finally coated and painted surfaces are also examples of hard surfaces that can be modified by the present invention to derive the desired benefits.

### Anti-Filming Agent

The present invention relates to a method of coating hard surfaces with an anti-filming agent. The anti-filming agent comprises a water-soluble alkoxylated acrylic acid. In one embodiment, the agent comprises a graft polymer having an acrylic acid backbone and alkoxylated side chains. The polymer should have a molecular weight of from about 4,000 to about 25,000, or from about 5,000 to about 20,000, or from about 6,000 to about 13,000. The alkylene oxide (AO) component of the polymer is generally selected from propylene oxide (PO) or ethylene oxide (EO) and generally comprises from about 20 wt % to about 50 wt %, or from about 30 wt % to about 45 wt %, or from about 30 wt % to about 40 wt % of the polymer. The alkoxylated side chains of the water-soluble polymer may comprise from about 10 to about 55 AO units, or from about 20 to about 50 AO units, or from about 25 to 50 AO units. The water-soluble polymers may be configured as random, block, graft, or combinations of these or other known configurations. Methods for forming alkoxylated acrylic acid polymers are disclosed in U.S. Pat. No. 3,880,765. The water-soluble polymer should comprise from about 0.5 wt % to about 30 wt % of total composition. Alternately, the water-soluble polymer comprises from about 1 wt % to about 25 wt %, or from about 5 wt % to about 20 wt % of the total composition.

The water-soluble polymer herein provides anti-spotting and anti-filming benefits when incorporated into hard surface coating compositions as an anti-filming agent. Without being limited by theory, the water-soluble polymer has strong calcium ion binding ability, while having water hardness tolerance. As used herein, polymers with “water hardness tolerance” do not readily precipitate from water upon binding to calcium ions.

Without being limited by theory, it is also believed that the water-soluble polymers form a single layer on hard surfaces, particularly on glass, by forming a calcium ion bridge between the water-soluble polymer and hard surface. Accordingly it is believed that the AO chains of the water-soluble polymer extend from the hard surface and prevent further deposition onto the hard surface.

As the anti-filming agent may function to sequester calcium and/or other metal ions, hard surface coating compositions may be formulated without the presence of a builder. Therefore, in one embodiment, the compositions are substantially free of a builder.

### Suitable Compositions

The coating composition may be in any form, such as liquids (aqueous or non-aqueous), granules, pastes, powders, spray, foam, tablets, gels, and the like. Granular compositions can be in “compact” form and the liquid compositions can also be in a “concentrated” form. Solid forms should generally be diluted in water prior to application to certain surfaces, such as glass. The coating compositions of the present invention encompass compositions that are used on any suitable hard surface including, but not limited to: fiberglass, plastics, metals, glass, ceramic, wood, stone, concrete, asphalt, mineral, coated surfaces, painted surfaces and mixtures thereof.

The coating compositions can also be used as detergent additives for hard surface cleaning applications or for automatic dishwashing machines. In the dishwashing context, such additive products are intended to supplement or boost the performance of conventional coating compositions and can be added at any stage of the dishwashing process. However, best results are achieved in the rinsing cycle.

Dry coating compositions can also be used as detergent additive products in powder, granule or tablet form for automatic dishwashing machines. Such additive products are intended to supplement or boost the performance of conventional coating compositions and can be added at any stage of the dishwashing process. However, best results are achieved in the rinsing cycle.

Further, the dry coating compositions according to the present invention may be in powder, granule, tablet or encapsulated complex form.

In some instances, such as in the case of automatic dishwashing compositions, it is generally desirable to maintain an alkaline pH in order to achieve acceptable cleaning. Therefore, in one embodiment, automatic dishwashing compositions comprising the anti-filming agent herein have a pH of from about 8 to about 12, alternately from about 9 to about 11, and yet alternately from about 9.5 to about 10.7.

In other compositions, such as rinse aid compositions for use in automatic dishwashers and spray-type hard surface cleaners, it may be desirable to maintain an acidic pH. In such compositions, the pH may be from about 1 to about 6.9, alternately from about 2 to about 6, and yet alternately from about 3 to about 5.8.

Typical cleaning compositions may include small amounts of a fugitive alkaline cleaner such as ammonia or other volatile alkaline materials such as alkanol amines or morpholine. Suitable amounts of the fugitive alkaline cleaner typically are within the range of from about 0.01% to 1 wt % with a preferred concentration lying within the range of from 0.03 to 0.07 wt % of the hard surface cleaning composition. Alternatively an acidic cleaner such as vinegar in an amount sufficient to provide acetic acid at a concentration of from about 0.01 to 0.5 wt %, preferably from 0.02 to 0.08 wt % of the hard surface cleaning composition is a suitable acidic cleaner.

The formulation may also contain one or more surfactants. Typical of anionic surfactants are the sulfonated fatty alcohols containing from about 8 to 18 carbon atoms, sulfated fatty oils or esters, sulfated polyethylene oxides, ethers or fatty alcohols and alkyl aryl sulfonates which are present in the form of the alkali metal salts thereof especially the sodium salts.

Suitable non-ionic surfactants include, for example, the polyethylene oxide ethers of fatty alcohols and polyoxyethylene ethers of alkyl phenols. Such surfactants include ethoxylated alcohols having a carbon chain length of from 6 to 12 carbon atoms.

The surfactant is typically present in an amount of from 0.01 to 0.5 wt %, preferably 0.05 to 0.1 wt %, of the hard surface cleaning composition of the present invention. Mixtures of the surfactants are suitable, and in some cases preferred, for incorporation into the cleaning composition.

In one non-limiting embodiment, the method herein comprises coating a hard surface with an anti-filming composition comprising the steps of: a) contacting said hard surface with an effective amount of a water-soluble alkoxylated acrylic acid polymer; and b) allowing said hard surface to dry. While the composition may be applied to any hard surface, in one embodiment, the method comprises applying the composition to glass and/or dishware. In the case of dishware, the method herein may include the step of loading an automatic dishwasher with dishware prior to contacting the dishware with the composition. The composition may be released into the wash during the main wash or rinse cycle. In other direct applications, the composition may be applied to a hard surface by atomizing the composition from a spry-type nozzle. Such direct applications may also include the step of wiping the surface with a cloth, wipe or wiping article to assist in the application, cleaning, and drying process.

### Test Methods

### Weight-Average Molecular Weight

The weight-average molecular weight (Mw) refers to the value measured by means of GPC (gel permeation chromatography).
Measurement device: “Shodex SYSTEM-2” manufactured by Showa Denko K.K.
Column: It is prepared by connecting in series the “Asahipak GF-710 HQ” and “Ashipak GF-310 HQ” manufactured by Showa Denko K.K.
Eluting liquid: 0.1N sodium acetate/acetonitrile=7/3 (ratio by volume)
Flow rate: 0.5 mL/min

### Temperature: 40° C.

Calibration line: It is prepared by using a standard sample of polyacrylic acid (product of Sowa

### Kagaku K.K.)

### Detector: RI

### Non-Limiting Examples

The compositions illustrated in the following Examples illustrate specific embodiments of the compositions of the present invention, but are not intended to be limiting thereof. Other modifications can be undertaken by the skilled artisan without departing from the spirit and scope of this invention. These exemplified embodiments of the composition of the present invention provide good anti-filming of hard surfaces.

The compositions illustrated in the following Examples are prepared by conventional formulation and mixing methods, an example of which is set forth herein below. All exemplified amounts are listed as weight percents and exclude minor materials such as diluents, preservatives, color solutions, imagery ingredients, botanicals, and so forth, unless otherwise specified.

| | Examples | | | | | | | | | | | | |
|---|---|---|---|---|---|---|---|---|---|---|---|---|---|
| Ingredient | 1 | 2 | 3 | 4 | 5 | 6 | 7 | 8 | 9 | 10 | 11 | 12 | 13 |
| Nonionic Surfactant (1) | 25 | 30 | 15 | 10 | 30 | 20 | 1 | 1.5 | 0.5 | 1 | 1.5 | 0.5 | — |
| Citric Acid | 6 | — | 2 | 2 | 6 | 6 | — | — | — | — | — | — | — |
| Polyacryalte copolymer (20% | 3 | 4 | 5 | 5 | 7 | 5 | — | — | — | — | — | — | — |
| neutralized) (2) | | | | | | | | | | | | | |
| Hydrotrope (3) | 7 | 12 | 5 | 10 | 5 | 3 | — | — | — | — | — | — | — |
| Ethanol | 6 | 5 | 7 | 3 | 3 | 5 | .5 | — | 1 | .5 | — | 1 | — |
| Perfume | — | 0.25 | — | 0.12 | — | — | .3 | .3 | — | .3 | .3 | — | — |
| Zinc Oxide | — | — | — | 0.5 | — | — | — | — | — | — | — | — | — |
| Nitric acid | 0.1 | 0.2 | 0.1 | 0.1 | — | 0.1 | — | — | — | — | — | — | — |
| ZnCl2 | — | — | — | 0.8 | 0.5 | — | — | — | — | — | — | — | — |
| Water Soluble Polymer (4) | 10 | — | — | — | — | — | 1 | — | — | — | — | — | — |
| Water Soluble Polymer (5) | — | 15 | — | — | — | — | — | 1 | — | — | — | — | — |
| Water Soluble Polymer (6) | — | — | 20 | — | — | — | — | — | 1 | — | — | — | — |
| Water Soluble Polymer (7) | — | — | — | 30 | — | — | — | — | — | 1 | — | — | — |
| Water Soluble Polymer (8) | — | — | — | — | 5 | — | — | — | — | — | 1 | — | — |
| Water Soluble Polymer (9) | — | — | — | — | — | 1 | — | — | — | — | — | 1 | — |
| Water Soluble Polymer (10) | — | — | — | — | — | — | — | — | — | — | — | — | 1 |
| Water and Minors (q.s. to 100%) | q.s. | q.s. | q.s. | q.s. | q.s. | q.s. | q.s. | q.s. | q.s. | q.s. | q.s. | q.s. | q.s. |

(1) Plurafac RA-30 available from BASF
(2) Acusol 480 N ™ available from Rohm & Haas
(3) Naxonate 45SC available from Nease Performance Chemicals
(4) Acrylic acid/ethylene oxide copolymer having 50 EO units, MW 6,000, and ratio of acrylic acid to ethylene oxide ~80:20
(5) Acrylic acid/ethylene oxide copolymer having 50 EO units, MW 9,000, and ratio of acrylic acid to ethylene oxide ~60:40
(6) Acrylic acid/ethylene oxide copolymer having 50 EO units, MW 13,000, and ratio of acrylic acid to ethylene oxide ~60:40
(7) Acrylic acid/ethylene oxide copolymer having 10 EO units, MW 7,000, and ratio of acrylic acid to ethylene oxide ~65:35
(8) Acrylic acid/ethylene oxide copolymer having 25 EO units, MW 5,000, and ratio of acrylic acid to ethylene oxide ~65:35
(9) Acrylic acid/ethylene oxide copolymer having 50 EO units, MW 5,500, and ratio of acrylic acid to ethylene oxide ~70:30
(10) Acrylic acid/ethylene oxide copolymer having 25 EO units, MW 8,000, and ratio of acrylic acid to ethylene oxide ~60:40

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, are, in relevant part, incorporated herein by reference; the citation of any document is not to be construed as an admission that it is prior art with respect to the present invention.

While particular embodiments have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of coating a hard surface with an anti-filming composition comprising the steps of:
a) contacting said hard surface with an effective amount of a water-soluble alkoxylated acrylic acid polymer; and
b) allowing said hard surface to dry.

2. A method according to claim 1, wherein said hard surface comprises glass.

3. A method according to claim 1, wherein said step a) is preceded by loading said composition into a rinse-aid chamber of an automatic dishwashing machine.

4. A method according to claim 1, wherein said step a) is preceded by atomizing or dispensing said composition from a container comprising a spray-type nozzle.

5. A method according to claim 1, wherein step b) is preceded by the step of wiping said hard surface with a cloth, wipe, or wiping article.

6. A method according to claim 1, wherein said polymer comprises a molecular weight of from about 4,000 to about 25,000.

7. A method according to claim 1, wherein said polymer comprises a molecular weight of from about 5,000 to about 20,000.

8. A method according to claim 1, wherein said polymer comprises a molecular weight of from about 5,000 to about 13,000.

9. A method according to claim 1, wherein said polymer comprises from about 20 wt % to about 50 wt % of alkylene oxide.

10. A method according to claim 9, wherein said alkylene oxide component is present as alkoxylated side chains on said polymer.

11. A method according to claim 10, wherein said alkoxylated side chains comprise from about 10 to about 55 AO units.

12. A method according to claim 9, wherein said alkoxylated side chains comprise units selected from PO units and EO units.

13. A method according to claim 9, wherein said polymer comprises a molecular weight of from about 5,000 to about 20,000 and from about 25 to about 50 AO units.

14. A method according to claim 1, wherein said composition is substantially free of a builder.

15. A method according to claim 1, wherein said hard surface is dishware.

16. A method according to claim 1, wherein said hard surface is glass.
